(19) United States
(12) Patent Application Publication
(10) Pub. No.: US 2011/0175882 A1
(43) Pub. Date: Jul. 21, 2011

(54) PIXEL CIRCUIT, AND DISPLAY APPARATUS AND METHOD OF DRIVING DISPLAY APPARATUS USING THE PIXEL CIRCUIT

(75) Inventors: Denis Stryakhilev, Yongin-city (KR); Ki-Nyeng Kang, Yongin-city (KR); Tae-Woong Kim, Yongin-city (KR); Dong-Gun Jin, Yongin-city (KR); Jin-Seong Park, Yongin-city (KR)

(73) Assignee: Samsung Mobile Display Co., Ltd., Yongin-city (KR)

(21) Appl. No.: 12/982,287

(22) Filed: Dec. 30, 2010

(30) Foreign Application Priority Data
Jan. 21, 2010 (KR) 10-2010-0005744

(51) Int. Cl. G09G 5/00

(52) U.S. Cl. 345/211

(57) ABSTRACT

A pixel circuit for a display apparatus is disclosed. The pixel circuit includes two scan transistors. The scan transistors are driven such that when not connecting a storage capacitor to a data line, one of the scan transistors is off, and one of the scan transistors is driven with a voltage to reverse a threshold shift caused by the voltage applied to turn the transistor off.

### CROSS-REFERENCE TO RELATED APPLICATIONS

This application claims the benefit of Korean Patent Application No. 10-2010-0005744, filed on Jan. 21, 2010, in the Korean Intellectual Property Office, the disclosure of which is incorporated herein in its entirety by reference.

### BACKGROUND

1. Field

The disclosed technology relates to a pixel circuit and a display apparatus, and a method of driving a display apparatus using the pixel circuit.

2. Description of the Related Technology

Display devices apply a data signal, which corresponds to input data, to a plurality of pixel circuits so as to control the luminance of each of the pixels so as to display an image based on the input. The data signal to be output to the plurality of pixel circuits is generated from a data driving unit. The data driving unit selects a gamma voltage, which corresponds to the input data, from among a plurality of gamma voltages generated from a gamma filter circuit unit, and outputs the selected gamma voltage as a data signal for the plurality of pixel circuits.

An organic electro-luminescent display apparatus electrically excites fluorescent organic compounds to emit light. In the organic electro-luminescent display apparatus, organic electro-light emitting devices arranged in a matrix are driven by a voltage or current so as to display an image. The organic electro-light emitting devices have characteristics of a diode and are called OLEDs.

An OLED has a structure in which an anode, which may comprise indium tin oxide (ITO), an organic thin film, and a cathode, which may comprise a metal, are stacked. In order to balance electrons and holes and thus improve luminance efficiency, the organic thin film includes an emitting layer (EML), an electron transport layer (ETL), and a hole transport layer (HTL). The organic thin film may further include a hole injection layer (HIL) and/or an electron injection layer (EIL).

### SUMMARY OF CERTAIN INVENTIVE ASPECTS

One aspect is a pixel circuit for outputting driving current to a light-emitting device. The pixel circuit includes a driving transistor configured to output the driving current to the light-emitting device according to a data signal that is input to a gate of the driving transistor, where the driving transistor includes a first electrode, which is connected to a first power voltage, and a second electrode connected to the light-emitting device. The pixel circuit also includes a storage capacitor connected between the gate electrode of the driving transistor and the second electrode of the driving transistor, a first scan transistor including, a first electrode connected to a data line configured to transmit the data signal, a second electrode, and a gate electrode connected to a first scan control signal line. The pixel circuit also includes and a second scan transistor including a first electrode connected to the second electrode of the first scan transistor, a second electrode connected to the gate electrode of the driving transistor, and a gate electrode connected to a second scan control signal line. The first scan control signal and the second scan control signal are driven such that during a first time period, both the first scan control signal and the second scan control signal have a first level which causes the first scan transistor and the second scan transistor to be on, during a second time period, the second scan control signal has a second level which causes the second scan transistor to be off and the first scan control signal has a third level that is between the first level and the second level, during a third time period, both the first scan control signal and the second scan control signal have the first level, and during a fourth time period, the first scan control signal has the second level and the second scan control signal has the third level.

Another aspect is a display system, which includes a plurality of pixels, a data driving unit configured to output a data signal through a data line to the plurality of pixels, and a scan driving unit configured to output a first scan control signal and a second scan control signal to the plurality of pixels. The pixels each include a light-emitting device and a pixel circuit for outputting driving current to the light-emitting device. The pixel circuit includes a driving transistor configured to output the driving current to the light-emitting device according to a data signal that is input to a gate of the driving transistor, the driving transistor including a first electrode, which is connected to a first power voltage, and a second electrode connected to the light-emitting device. The pixel circuit also includes a storage capacitor connected between the gate electrode of the driving transistor and the second electrode of the driving transistor, a first scan transistor including a first electrode connected to a data line configured to transmit the data signal, a second electrode, and a gate electrode connected to a first scan control signal line. The pixel circuit also includes a second scan transistor including a first electrode connected to the second electrode of the first scan transistor, a second electrode connected to the gate electrode of the driving transistor, and a gate electrode connected to a second scan control signal line. The scan driving unit is configured to drive the first scan control signal and the second scan control such that during a first time period, both the first scan control signal and the second scan control signal have a first level which causes the first scan transistor and the second scan transistor to be on, during a second time period, the second scan control signal has a second level which causes the second scan transistor to be off and the first scan control signal has a third level that is between the first level and the second level, during a third time period, both the first scan control signal and the second scan control signal have the first level, and during a fourth time period, the first scan control signal has the second level and the second scan control signal has the third level.

Another aspect is a method of driving a display apparatus including a pixel circuit including a driving transistor and first and second scan transistors, where the first scan transistor responds to a first scan control signal and transmits a data signal to the second scan transistor, and the second scan transistor responds to a second scan control signal and transmits the data signal to a gate electrode of the driving transistor. The method includes during a first time period, driving both the first scan control signal and the second scan control signal with a first level which causes the first scan transistor and the second scan transistor to be on, during a second time period, driving the second scan control signal with a second level which causes the second scan transistor to be off and the first scan control signal has a third level that is between the first level and the second level, during a third time period, driving both the first scan control signal and the second scan control signal with the first level, and during a fourth time period, driving the first scan control signal with the second level and the second scan control signal has the third level.

Another aspect is a pixel circuit, including a storage capacitor, and first and second scan transistors serially connected between a data line and the storage capacitor. The first scan transistor includes a first gate electrode connected to a first scan control signal line, and the second scan transistor includes a second gate electrode connected to a second scan control signal line, where the first and second scan transistors are configured to transmit a data signal from the data line to the storage capacitor based on first and second scan control signals on the first and second scan control signal lines, respectively. The first scan control signal line and the second scan control signal line are driven such that during a first time period, both the first scan control signal and the second scan control signal have a first level which causes the first scan transistor and the second scan transistor to be on, during a second time period, the second scan control signal has a second level which causes the second scan transistor to be off and the first scan control signal has a third level that is between the first level and the second level, during a third time period, both the first scan control signal and the second scan control signal have the first level, and during a fourth time period, the first scan control signal has the second level and the second scan control signal has the third level.

### BRIEF DESCRIPTION OF THE DRAWINGS

The above and other features and advantages will become more apparent through description of exemplary embodiments with reference to the attached drawings in which:

FIG. 1 is a schematic diagram illustrating a luminescence principle of an organic light-emitting diode (OLED);

FIG. 2 is a schematic diagram illustrating an exemplary pixel circuit;

FIG. 3 is a graph illustrating a threshold voltage shift over time for various values of negative gate bias V_{STRESS};

FIG. 4A is a graph illustrating a gate bias V_{STRESS} applied to a transistor over time;

FIG. 4B is a graph illustrating a threshold voltage change of a transistor over time for gate biases V_{STRESS} of FIG. 4A;

FIG. 5 is a block diagram that illustrates the structure of an OLED display according to an embodiment;

FIG. 6 is a schematic diagram that illustrates a pixel circuit of a pixel, according to an embodiment;

FIG. 7 is a timing diagram illustrating a first scan control signal, a second scan control signal, and a data signal, according to an embodiment;

FIGS. 8A through 8C are circuit diagrams illustrating driving the pixel circuit of FIG. 6, according to an embodiment;

FIG. 9 is a schematic diagram that illustrates a pixel circuit of a pixel, according to another embodiment;

FIG. 10 is a schematic diagram that illustrates a pixel circuit of a pixel, according to another embodiment; and

FIG. 11 is a flowchart illustrating a method of driving a display apparatus.

### DETAILED DESCRIPTION OF CERTAIN INVENTIVE EMBODIMENTS

Embodiments will be described more fully with reference to the accompanying drawings. The detailed description and the drawings are introduced to provide understanding of inventive aspects and the detailed descriptions of some well-known technologies may be omitted. In addition, the specification and the drawing are not provided to limit the scope.

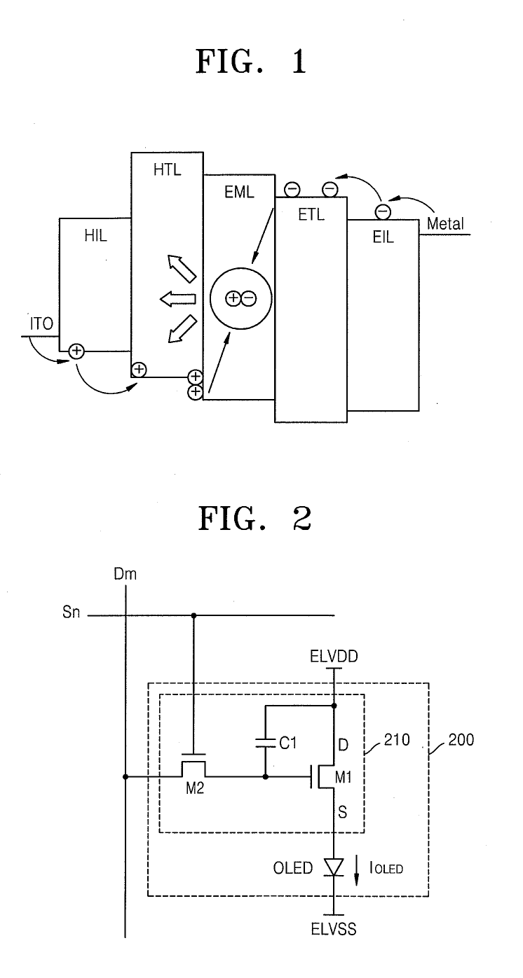

FIG. 1 is a schematic view illustrating a luminescence principle of an organic light-emitting diode (OLED).

Display embodiments presented below may employ the OLED as a light-emitting device. However, the present invention is not limited thereto, and other flat panel displays such as liquid crystal displays (LCD), electrophoretic displays (EPD), or the like may also be used.

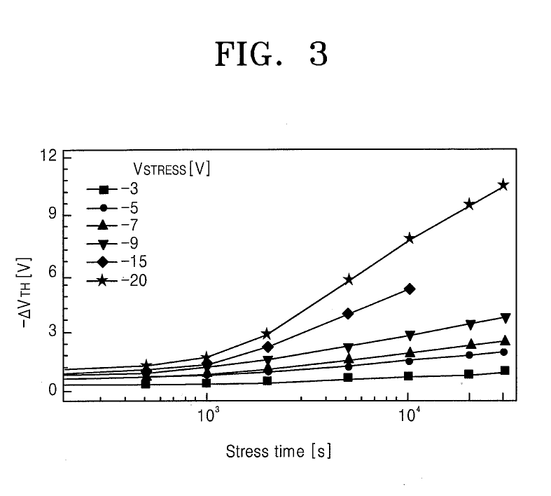

FIG. 2 is a view illustrating an exemplary pixel circuit 210. Pixel circuits according to various embodiments may be implemented using n-type transistors and/or p-type transistors. Hereinafter, various embodiments are described with reference to a pixel circuit implemented using n-type transistors.

An organic electro-luminescent display apparatus includes a plurality of pixels 200 each including an OLED and a pixel circuit, such as pixel circuit 210. The OLED receives driving current I_{OLED} output from the pixel circuit 210 and emits light. The luminance of light emitted from the OLED varies according to the driving current I_{OLED}.

The pixel circuit 210 includes a capacitor C1, a driving transistor M1, and a scan transistor M2.

When a scan control signal Sn is applied to the scan transistor M2, a data signal Dm is applied through the scan transistor M2 to a gate of the driving transistor M1 and a first terminal of the capacitor C1. While the data signal Dm is applied, a voltage level corresponding to that of the data signal Dm is charged in the capacitor C1. According to the value of the data signal Dm, the driving transistor M1 generates the driving current I_{OLED} and outputs the generated driving current I_{OLED} to the OLED.

The OLED receives the driving current I_{OLED} from the pixel circuit 210 and emits light having luminance corresponding to the data signal Dm.

In the pixel circuit 210 of FIG. 2, which is implemented using an n-type transistor, a negative gate bias is applied to the scan transistor M2 during most of the time. A positive gate bias is applied to the scan transistor M2 only during the programming time when the data signal Dm is applied to the driving transistor M1. In some embodiments, the programming time is considerably shorter than the time the negative gate bias is applied to the scan transistor M2. Unfortunately, when the negative gate bias is applied to the scan transistor M2 between programming periods, the scan transistor M2 experiences a threshold voltage shift, as illustrated in FIG. 3.

FIG. 3 is a graph illustrating a threshold voltage shift for applied stress time for various values of negative gate bias V_{STRESS}.

As illustrated in FIG. 3, as the negative gate bias V_{STRESS} increases, the amplitude of threshold voltage shift −ΔV_{TH} increases. Also, as the stress time (s) that the negative gate bias V_{STRESS} is applied increases, the amplitude of the threshold voltage shift−ΔV_{TH} increases.

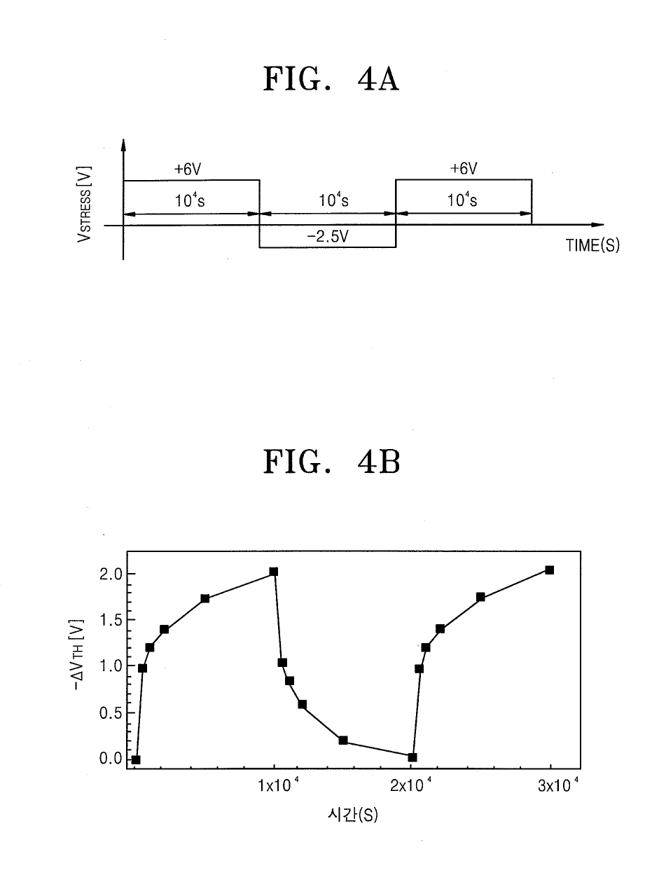

FIG. 4A is a graph illustrating a gate bias V_{STRESS} applied to a transistor over time. FIG. 4B is a graph illustrating a threshold voltage change of a transistor over time for applied gate biases V_{STRESS} of FIG. 4A.

As illustrated in FIG. 4A, the gate bias V_{STRESS} may be applied to the transistor. As illustrated in FIG. 4B, the threshold voltage of the transistor continuously varies due to the applied gate biases V_{STRESS} of FIG. 4A. The threshold voltage variation is greater as time passes. Furthermore, as the gate bias V_{STRESS} continuously varies as illustrated in FIG. 4A, the threshold voltage change is repeated. Such threshold voltage change generates a leakage current, which may lead to the deterioration of the transistor.

If the threshold voltage is shifted in a negative direction, the scan transistor M2 may deliver a leakage current between programming durations. Thus, the data line and the pixel are not insulated by the scan transistor M2 between the programming periods, and cross-talk is generated between the pixels. In addition, this phenomenon intensifies as time passes. As a result, picture quality of a display apparatus deteriorates.

In some embodiments, an additional scan transistor is arranged in series with the scan transistor, and a driving signal applied to the scan transistor is changed so as to reduce the gate bias applied to the scan transistor.

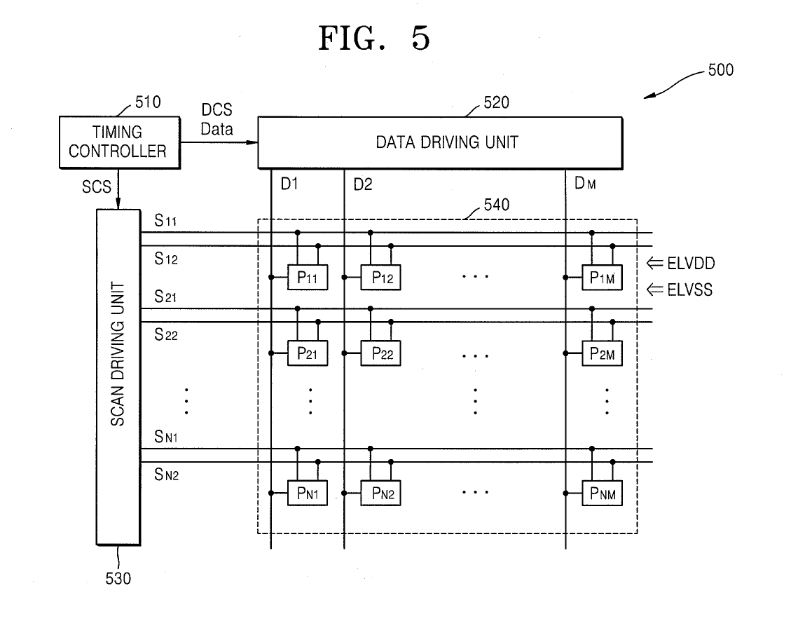

FIG. 5 illustrates a structure of a display apparatus 500 according to some embodiments.

The display apparatus 500 includes a timing controller 510, a data driving unit 520, a scan driving unit 530, and a plurality of pixels 540.

The timing controller 510 generates RGB data Data and a data driving unit control signal DCS and outputs the generated RGB data Data and the data driving unit control signal DCS to the data driving unit 520. The timing controller 510 also generates a scan driving unit control signal SCS and outputs the generated scan driving unit control signal SCS to the scan driving unit 530.

The data driving unit 520 generates a data signal Dm from the RGB data Data and outputs the generated data signal Dm to the plurality of pixels 540. The data driving unit 520 may generate the data signal Dm from the RGB data Data by using a gamma filter (not shown) and a digital-analog conversion circuit (not shown). During a single scanning period, the data signal Dm may be output to each of the plurality of pixels located in a single row. In addition, each of a plurality of data lines which transmits the data signal Dm may be connected to the plurality of pixels located in the row.

The scan driving unit 530 generates a first scan control signal Sn1 and a second scan control signal Sn2 according to the scan driving unit control signal SCS and outputs the generated first scan control signal Sn1 and the second scan control signal Sn2 to the pixels 540. Each first scan control signal line transmitting the first scan control signal Sn1 and each second scan control signal line transmitting the second scan control signal Sn2 may be connected to the pixels located in a single row. The first scan control signal Sn1 and the second scan control signal Sn2 may be sequentially activated for each of the rows.

The scan driving unit 530 according to the current embodiment may drive the first scan control signal Sn1 and the second scan control signal Sn2 by repeating a first time duration in which both the first scan control signal Sn1 and the second scan control signal Sn2 have a first level, a second time duration in which the second scan control signal Sn2 has a second level and the first scan control signal Sn1 has a third level that is between the first level and the second level, a third time duration in which both the first scan control signal Sn1 and the second scan control signal Sn2 have a first level, and a fourth time duration in which the first scan control signal Sn1 has a second level and the second scan control signal Sn2 has a third level.

As illustrated in FIG. 5, the pixels 540 may be arranged in an N×M matrix. Each of the pixels 540 may include an OLED and a pixel circuit for driving the OLED. A first power voltage ELVDD and a second power voltage ELVSS may be applied to each of the pixels 540. Each of the pixels 540 according to some embodiments includes a first scan transistor and a second scan transistor. The first scan control signal Sn1 is applied to a gate of the first scan transistor, and the second scan control signal Sn2 is applied to a gate of the second scan transistor. The first level is a level at which the first scan transistor and the second scan transistor are turned-on, the second level is a level at which the first scan transistor and the second scan transistor are turned-off, and the third level is a middle level between the first level and the second level. The third level may be determined as a level at which a negative threshold voltage is not generated in a transistor.

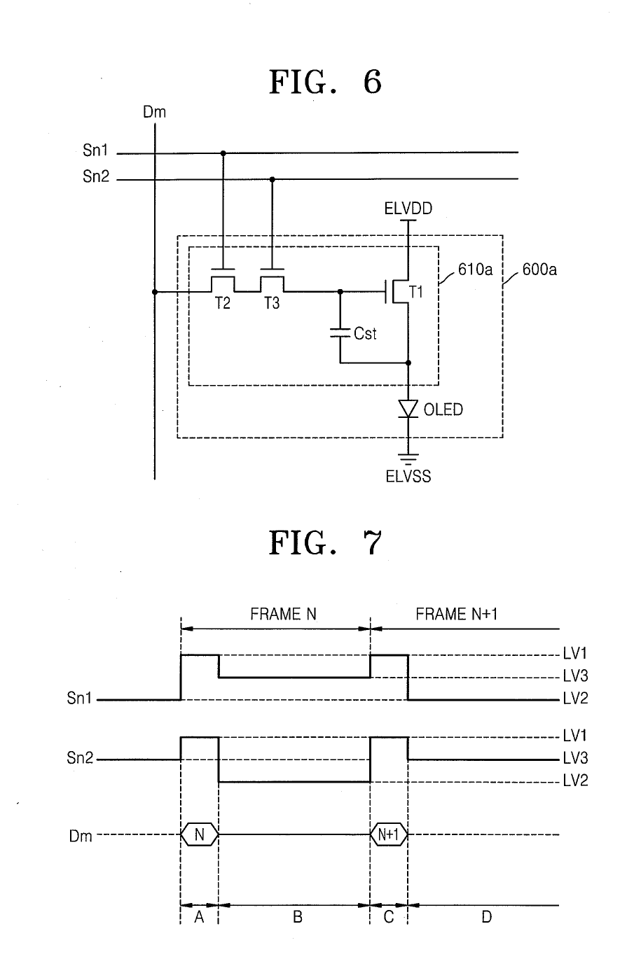

FIG. 6 illustrates a pixel circuit 610a of a pixel 600a, according to an embodiment.

The pixel 600a includes the pixel circuit 610a and an OLED. The pixel circuit 610a includes a driving transistor T1, a first scan transistor T2, a second scan transistor T3, and a storage capacitor Cst.

The driving transistor T1 includes a first electrode, which is connected to a first power voltage ELVDD, and a second electrode connected to the OLED.

The first scan transistor T2 includes a gate electrode connected to a first scan control signal Sn1, a first electrode connected to a data line for transmitting a data signal Dm, and a second electrode.

The second scan transistor T3 includes a gate electrode connected to a second scan control signal Sn2, a first electrode connected to the second electrode of the first scan transistor T2, and a second electrode connected to a gate electrode of the driving transistor T1.

The storage capacitor Cst is connected to the gate electrode of the driving transistor T1 and to the second electrode of the driving transistor T1.

FIG. 7 is a timing diagram illustrating a first scan control signal, a second scan control signal, and a data signal, according to an embodiment.

The first scan control signal Sn1 and the second scan control signal Sn2 according to the some embodiments alternately have a reverse shifting period and an off period between programming periods (between A and C). During the reverse shifting period, the gate bias applied to either of the first scan transistor T2 and second scan transistor T3 is reduced. As a result, the threshold voltage shift of the first scan transistor T2 and second scan transistor T3 is reversed and aging of the display apparatus is reduced.

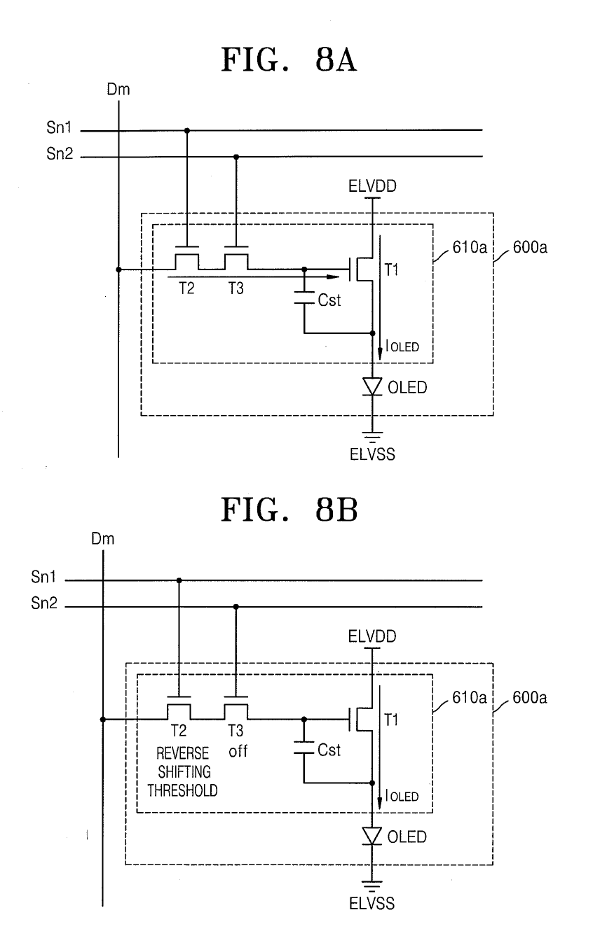

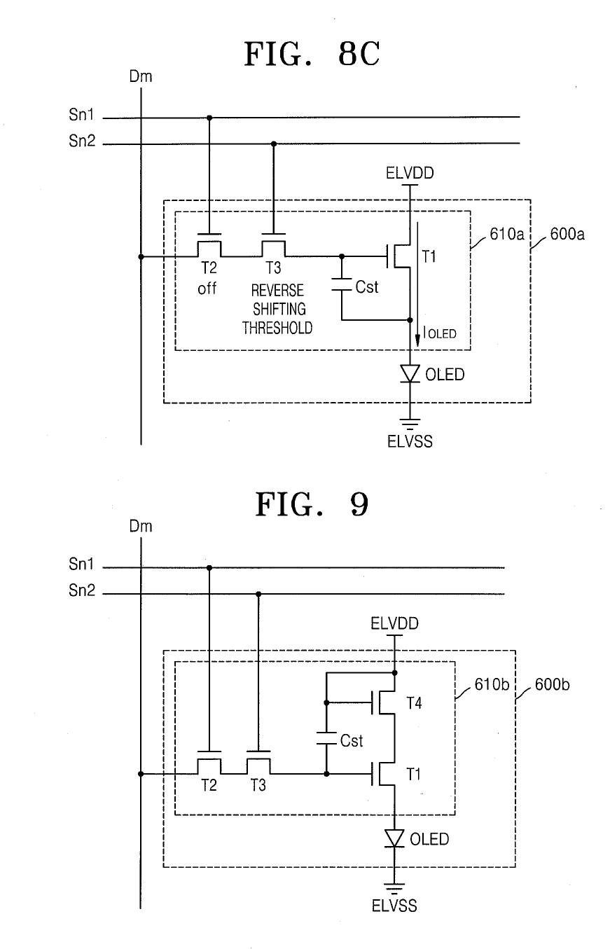

FIGS. 8A through 8C are circuit diagrams illustrating an operation of the pixel circuit 610a, according to an embodiment. The operation of the pixel circuit 610a is described with reference to FIGS. 7 and 8A through 8C.

During a first time period A, both the first scan control signal Sn1 and the second scan control signal Sn2 have a first level LV1, and data signal Dm has a valid level. As illustrated in FIG. 8A, since the first scan transistor T2 and second scan transistor T3 are on, the data signal Dm is applied to the gate electrode of the driving transistor and storage capacitor Cst. The storage capacitor Cst stores the data signal Dm during the first time period A. When the data signal Dm is applied to the gate electrode, the driving transistor T1 generates driving current I_{OLED} corresponding to the data signal Dm and outputs the generated driving current I_{OLED} to an OLED.

During a second time period B, the first scan control signal Sn1 has a third level LV3, and the second scan control signal Sn2 has a second level. LV2. Thus, as illustrated in FIG. 8B, the shift in threshold voltage of the first scan transistor T2 is reversed, and the second scan transistor T3 is turned-off. Since the second scan transistor T3 is turned-off, the data line for transmitting the data signal Dm, and the gate electrode of the driving transistor T1 are electrically isolated from each other. The driving transistor T1 continuously generates the driving current I_{OLED} using the data signal Dm stored in the storage capacitor Cst and outputs the generated driving current I_{OLED} to the OLED.

During a third time period C, both the first scan control signal Sn1 and the second scan control signal Sn2 have a first level LV1, and the data signal Dm has a valid level corresponding to data of the next frame. As illustrated in FIG. 8A, since the first scan transistor T2 and the second scan transistor T3 are turned-on, the data signal Dm is applied to the gate electrode of the driving transistor T1 and the storage capacitor Cst. Thus, a data signal Dm of the next frame is programmed in the storage capacitor Cst, and the driving transistor T1 generates driving current I_{OLED} corresponding to the data signal Dm and outputs the generated driving current I_{OLED} to the OLED.

During a fourth time period D, the first scan control signal Sn1 has the second level LV2, and the second scan control signal Sn2 has the third level LV3. As illustrated in FIG. 8C, the first scan transistor T2 is turned-off by the first scan control signal Sn1, and the threshold voltage shift of the second scan transistor T3 is reversed by the second scan control signal Sn2. Since the first scan transistor T2 is turned-off, the data line and the gate electrode of the driving transistor T1 are electrically isolated. The driving transistor T1 generates driving current I_{OLED} according to the data signal Dm stored in the storage capacitor Cst and outputs the generated driving current I_{OLED} to the OLED.

FIG. 9 illustrates a pixel circuit 610b of a pixel 600b according to another embodiment.

The pixel circuit 610b of the pixel 600b further includes a third transistor T4 that is connected between the first power voltage ELVDD and driving transistor T1. The storage capacitor Cst is connected between a gate electrode of the driving transistor T1 and a gate electrode of the third transistor T4, and the gate electrode of the third transistor T4 and the first power voltage ELVDD are electrically connected to each other.

The third transistor T4 has a gate electrode and a drain electrode, which are electrically connected to each other, and always operates in a saturation area. Accordingly, the third transistor T4 operates as a resistance, and a voltage drop in the third transistor T4 is determined according to the driving current I_{OLED}. As the display apparatus 500 ages, both the threshold voltage of the driving transistor T1 and the threshold voltage of the OLED increase because of a device characteristic shift, and thus the level of the driving current I_{OLED} decreases. As the amplitude of the driving current I_{OLED} decreases, the voltage applied across the third transistor T4 also decreases. Thus, the drain-source voltage of the driving transistor T1 is increased, thereby increasing the amplitude of the driving current I_{OLED} that is output from the driving transistor T1. The increase in the driving current I_{OLED} compensates for the device characteristic shift of the driving transistor T1 and the OLED. Accordingly, according to this embodiment, the threshold voltage shift of the driving transistor T1 and the OLED may be compensated for.

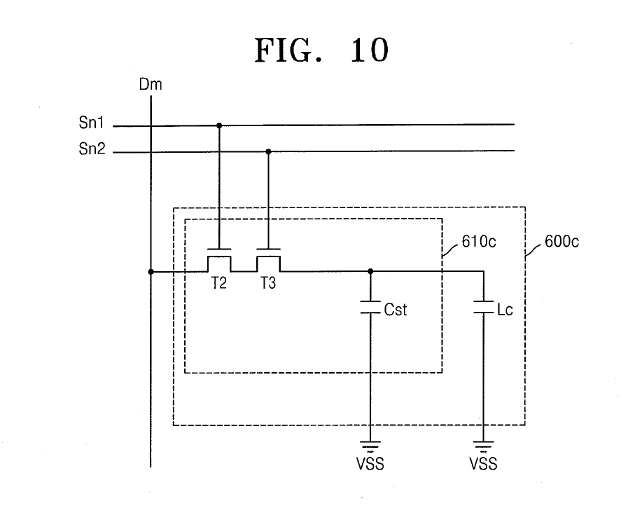

FIG. 10 illustrates a pixel circuit 610C of a pixel 600c, according to another embodiment.

The embodiment of FIG. 10 may be implemented on a liquid crystal display apparatus as illustrated in FIG. 10, and a light-emitting device may be a liquid crystal cell LC. Operations of the first scan transistor T2 and the second scan transistor T3 may be the same as those described in FIGS. 6 through 8.

The present invention may also be implemented as an electrophoretic display (EPD).

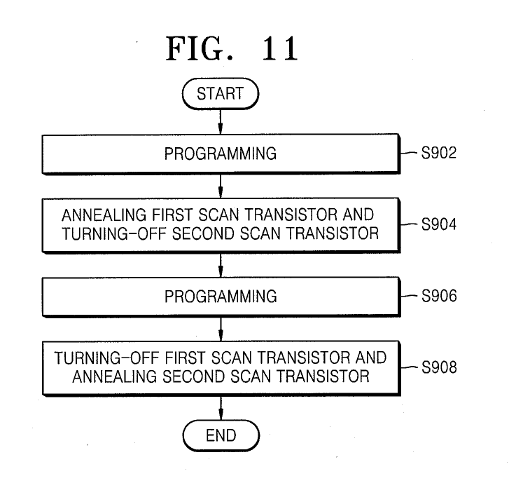

FIG. 11 is a flowchart illustrating a method of driving a display apparatus, according to an embodiment.

The method according to the method of FIG. 11 includes driving pixel circuits including a first scan transistor T2 and a second scan transistor T3, such as that shown in FIG. 6.

During a first time period A, a first scan control signal Sn1 and a second scan control signal Sn2 have a first level LV1. As a result, the first scan transistor T2 and the second scan transistor T3 are turned-on. Thus, a data signal Dm is programmed in a storage capacitor Cst (S902). As a result, driving current I_{OLED} according to the data signal Dm is output to an OLED either during time period A or at another time.

During a second time period B, the first scan control signal Sn1 has a third level LV3 and the second scan control signal Sn2 has a second level LV2. As a result, the threshold voltage shift of the first scan transistor T2 is reversed and the second scan transistor T3 is turned-off (S904). Thus, the driving current I_{OLED} is output to the OLED according to the data signal Dm stored in the storage capacitor Cst.

During a third time period C, the first scan control signal Sn1 and the second scan control signal Sn2 have the first level LV1, the first scan transistor T2 and the second scan transistor T3 are turned-on. Thus, a data signal Dm of the next frame is programmed in the storage capacitor Cst (S906). As a result, the driving current I_{OLED} according to the data signal Dm is output to the OLED either during time period C or at another time.

During a fourth time period D, the first scan control signal Sn1 has the second level LV2 and the second scan control signal Sn2 the a third level LV3. Accordingly, the first scan transistor T2 is turned-off and the threshold voltage shift of the second scan transistor T3 is reversed (S908). Thus, the driving current I_{OLED} is output to the OLED according to the data signal Dm stored in the storage capacitor Cst.

Embodiments include a voltage threshold shift reversing period, so that a leakage current due to a threshold voltage shift of a scan transistor can be prevented from being generated. In addition, the scan transistor can be prevented from aging due to repeated switching operations.

While various inventive aspects have been particularly shown and described with reference to exemplary embodiments, it will be understood by one of ordinary skill in the art that various changes in form and details may be made therein without departing from the spirit and scope of the present invention.

What is claimed is:

1. A pixel circuit for outputting driving current to a light-emitting device, the pixel circuit comprising:
a driving transistor configured to output the driving current to the light-emitting device according to a data signal that is input to a gate of the driving transistor, the driving transistor comprising a first electrode, which is connected to a first power voltage, and a second electrode connected to the light-emitting device;
a storage capacitor connected between the gate electrode of the driving transistor and the second electrode of the driving transistor;
a first scan transistor comprising, a first electrode connected to a data line configured to transmit the data signal, a second electrode, and a gate electrode connected to a first scan control signal line; and
a second scan transistor comprising a first electrode connected to the second electrode of the first scan transistor, a second electrode connected to the gate electrode of the driving transistor, and a gate electrode connected to a second scan control signal line,
wherein the first scan control signal and the second scan control signal are driven such that:
during a first time period, both the first scan control signal and the second scan control signal have a first level which causes the first scan transistor and the second scan transistor to be on,
during a second time period, the second scan control signal has a second level which causes the second scan transistor to be off and the first scan control signal has a third level that is between the first level and the second level,
during a third time period, both the first scan control signal and the second scan control signal have the first level, and
during a fourth time period, the first scan control signal has the second level which causes the first scan transistor to be off and the second scan control signal has the third level.

2. The pixel circuit of claim 1, wherein the driving transistor, the first scan transistor, and the second scan transistor are n-type metal-oxide semiconductor field effect transistors (MOSFETs).

3. The pixel circuit of claim 1, wherein the driving transistor, the first scan transistor, and the second scan transistor are p-type MOSFETs.

4. The pixel circuit of claim 1, further comprising a fourth transistor, which is connected between the driving transistor and the first power voltage, and has a gate electrode connected to the first power voltage.

5. The pixel circuit of claim 1, wherein the light-emitting device comprises a light-emitting device for one of: an organic electro-luminescent display apparatus, a liquid crystal display apparatus, and an electrophoretic display (EPD).

6. A display system comprising:
a plurality of pixels;
a data driving unit configured to output a data signal through a data line to the plurality of pixels; and
a scan driving unit configured to output a first scan control signal and a second scan control signal to the plurality of pixels,
wherein the pixels each comprise a light-emitting device and a pixel circuit for outputting driving current to the light-emitting device, and the pixel circuit comprises:
a driving transistor configured to output the driving current to the light-emitting device according to a data signal that is input to a gate of the driving transistor, the driving transistor comprising a first electrode, which is connected to a first power voltage, and a second electrode connected to the light-emitting device;
a storage capacitor connected between the gate electrode of the driving transistor and the second electrode of the driving transistor;
a first scan transistor comprising, a first electrode connected to a data line configured to transmit the data signal, a second electrode, and a gate electrode connected to a first scan control signal line; and
a second scan transistor comprising a first electrode connected to the second electrode of the first scan transistor, a second electrode connected to the gate electrode of the driving transistor, and a gate electrode connected to a second scan control signal line,
wherein the scan driving unit is configured to drive the first scan control signal and the second scan control such that:
during a first time period, both the first scan control signal and the second scan control signal have a first level which causes the first scan transistor and the second scan transistor to be on,
during a second time period, the second scan control signal has a second level which causes the second scan transistor to be off and the first scan control signal has a third level that is between the first level and the second level,
during a third time period, both the first scan control signal and the second scan control signal have the first level, and
during a fourth time period, the first scan control signal has the second level which causes the first scan transistor to be off and the second scan control signal has the third level.

7. The display apparatus of claim 6, wherein the driving transistor, the first scan transistor, and the second scan transistor are n-type MOSFETs.

8. The display apparatus of claim 6, wherein the driving transistor, the first scan transistor, and the second scan transistor are p-type MOSFETs.

9. The display apparatus of claim 6, wherein the pixel circuit further comprises a fourth transistor, which is connected between the driving transistor and the first power voltage, and has a gate electrode connected to the first power voltage.

10. The display apparatus of claim 6, wherein the display apparatus is one of an organic electro-luminescent display apparatus, a liquid crystal display apparatus, and an electrophoretic display (EPD).

11. A method of driving a display apparatus comprising a pixel circuit comprising a driving transistor and first and second scan transistors, wherein the first scan transistor responds to a first scan control signal and transmits a data signal to the second scan transistor, and the second scan transistor responds to a second scan control signal and transmits the data signal to a gate electrode of the driving transistor, the method comprising:
during a first time period, driving both the first scan control signal and the second scan control signal with a first level which causes the first scan transistor and the second scan transistor to be on,
during a second time period, driving the second scan control signal with a second level which causes the second scan transistor to be off and the first scan control signal has a third level that is between the first level and the second level,
during a third time period, driving both the first scan control signal and the second scan control signal with the first level, and
during a fourth time period, driving the first scan control signal with the second level which causes the first scan transistor to be off and the second scan control signal has the third level.

12. The method of claim 11, wherein the first scan transistor, the second scan transistor, and the driving transistor are n-type MOSFETs.

13. The method of claim 11, wherein the first scan transistor, the second scan transistor, and the driving transistor are p-type MOSFETs.

14. The method of claim 11, wherein the display apparatus is one of an organic electro-luminescent display apparatus, a liquid crystal display apparatus, and an electrophoretic display (EPD).

15. A pixel circuit, comprising:
a storage capacitor; and
first and second scan transistors serially connected between a data line and the storage capacitor, wherein the first scan transistor comprises a first gate electrode connected to a first scan control signal line, and the second scan transistor comprises a second gate electrode connected to a second scan control signal line, wherein the first and second scan transistors are configured to transmit a data signal from the data line to the storage capacitor based on first and second scan control signals on the first and second scan control signal lines, respectively, and wherein the first scan control signal line and the second scan control signal line are driven such that:
during a first time period, both the first scan control signal and the second scan control signal have a first level which causes the first scan transistor and the second scan transistor to be on,
during a second time period, the second scan control signal has a second level which causes the second scan transistor to be off and the first scan control signal has a third level that is between the first level and the second level,
during a third time period, both the first scan control signal and the second scan control signal have the first level, and
during a fourth time period, the first scan control signal has the second level which causes the first scan transistor to be off and the second scan control signal has the third level.

16. The pixel circuit of claim 15, wherein the driving transistor, the first scan transistor, and the second scan transistor are n-type metal-oxide semiconductor field effect transistors (MOSFETs).

17. The pixel circuit of claim 15, wherein the driving transistor, the first scan transistor, and the second scan transistor are p-type MOSFETs.

18. The pixel circuit of claim 15, further comprising a fourth transistor, which is connected between the driving transistor and the first power voltage, and has a gate electrode connected to the first power voltage.

19. The pixel circuit of claim 15, wherein the storage capacitor is connected to a light-emitting device for one of an organic electro-luminescent display apparatus, a liquid crystal display apparatus, and an electrophoretic display (EPD).

20. The pixel circuit of claim 15, further comprising a driving transistor connected to the storage capacitor, wherein the driving transistor is configured to provide a current to a light emitting device according to the data signal.
